(19) United States
(12) Patent Application Publication
(10) Pub. No.: US 2014/0084898 A1
(43) Pub. Date: Mar. 27, 2014

(54) STEP DOWN CONVERTER

(71) Applicant: NATIONAL TSING HUA UNIVERSITY, Hsinchu (TW)

(72) Inventors: Ching-Tsai Pan, Hsinchu (TW); Po-Yen Chen, Taipei (TW); Ming-Chieh Cheng, Taipei (TW)

(73) Assignee: NATIONAL TSING HUA UNIVERSITY, Hsinchu (TW)

(21) Appl. No.: 13/707,852

(22) Filed: Dec. 7, 2012

(30) Foreign Application Priority Data
Sep. 26, 2012 (TW) 101135355

(51) Int. Cl. G05F 3/08

(52) U.S. Cl. CPC G05F 3/08
USPC 323/311

(57) ABSTRACT

A step down DC converter includes a switch, one end of the switch is coupled to a DC voltage source, and the other end of the switch is coupled to a first inductor and a first diode which serial coupled to the first inductor. The converter further includes an auto charge pump circuit which is coupled to the first inductor and the first diode and provides an output current to a load.

### TECHNICAL FIELD

The present invention relates to a conversion circuit, more especially a single stage step down converter.

### BACKGROUND

Due to the inductance of the energy storage element (such as, inductor) of the conventional Buck converter will impact the response time of the input current and the ripple of the output voltage. When the inductance of the inductor is relatively small, the response time of the input current of the Buck converter is short, but the ripple of the output voltage is relatively large. On the contrary, when the inductance of the inductor is relatively large, the response time of the input current of the Buck converter is long but can get the relatively small ripple of the output voltage. Therefore, the inductor with small inductance and the output capacitor with large capacitance are usually used in the conventional Buck converter, in order to shorten the response time of the input current and to reduce the ripple of the output voltage.

However, it is necessary to use electrolytic capacitors so as to get larger capacitances. And, electrolytic capacitors are susceptible impacted by the external environmental factors, such as switching and temperature issue, so as to making its short-lived, and further to shorten the live time of the Buck converter.

FIG. 1 illustrates a conventional schematic of Buck converter 10. The Buck converter 10 includes a switch 16, a diode D, an inductor L, and a capacitor C. When the switch 16 is turned on, a voltage source 12 charges the inductor L and the capacitor C, and provides energy to a load 14 simultaneously. When the switch 16 is turned off, the inductor L releases the storage energy to the capacitor C via the diode D, and provides energy to the load 14 simultaneously.

FIG. 2 illustrates a conventional schematic of a flyback converter 20. The flyback converter 20 is used as an isolation step down converter with 100 W or lower. Due to circuit is simple and low cost, the flyback transformer 28 shown in FIG. 2 can act as energy storage. The secondary winding of the flyback transformer 28 just need to couple a diode D and a capacitor C. From a cost perspective, the flyback converter 20 is competitive in this market. The flyback converter 20 includes a switch 26, a flyback transformer 28, a diode D, and a capacitor C. By controlling the on/off of the switch 26, the flyback transformer 28 storages and releases the energy by its magnetizing inductor. The diode D and the capacitor C of the secondary winding filter and rectify an output voltage Vₒ so as to get a DC voltage. By the flyback transformer 28, the flyback converter 20 has the several functions, such as electrically isolation, voltage transformation, and can acts as an inductor for energy storage. Basically, the flyback transformer 28 is not a transformer but a couple inductor. The energy which stores in the flyback transformer 28 can be transmitted to the secondary winding and charges the capacitor via the diode D, by controlling the on/off the switch 26, so as to retain the DC voltage as a default value.

When the switch 26 is turned on, the voltage source 22 charges the flyback transformer 28 and reverses bias the diode D, the capacitor C provides energy to the load 24 simultaneously. When the switch 26 is turned off, the flyback transformer 28 charges the capacitor C via the diode D and provides the energy to the load 24.

Accordingly, the inductor L in the conventional Buck converter 10 shown in FIG. 1 and the flyback transformer 28 in the flyback converter 20 shown in FIG. 2 are role as energy transmission and the major function of the capacitor C is to filter the output voltage.

### SUMMARY

One of the purposes of the invention is to disclose a single stage step down converter. The own-convert converter includes a switch, one end of the switch is coupled to a DC voltage source, and the other end of the switch is coupled to a first inductor and a first diode which serial coupled to the first inductor. The converter further includes an auto charge pump circuit which is coupled to the first inductor and the first diode and provides an output current to a load.

The present invention provides a step down converter which doesn't need to use electrolytic capacitors so as can lengthen the live time of the converter. In addition, the present invention can achieve the goal of the circuit structure adjustable and the advantage of the energy balance without use any active component by implement the auto charge pump circuit. Furthermore, the present invention provides a step down converter which has the advantage of fast response of input current, low ripple of the output voltage, and long life time.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a conventional schematic of a Buck converter.

FIG. 2 illustrates a conventional schematic of a flyback converter.

FIG. 3 illustrates a schematic of single stage step down converter in accordance with one embodiment of the present invention.

FIG. 4A illustrates an equivalent schematic of the step down converter of FIG. 3 in the first mode in accordance with one embodiment of the present invention.

FIG. 4B illustrates an equivalent schematic of the step down converter of FIG. 3 in the second mode in accordance with one embodiment of the present invention.

FIG. 4C illustrates an equivalent schematic of the step down converter of FIG. 3 in the third mode in accordance with one embodiment of the present invention.

FIG. 4D illustrates an equivalent schematic of the step down converter of FIG. 3 in the fourth mode in accordance with one embodiment of the present invention.

FIG. 4E illustrates an equivalent schematic of the step down converter of FIG. 3 in the fifth mode in accordance with one embodiment of the present invention.

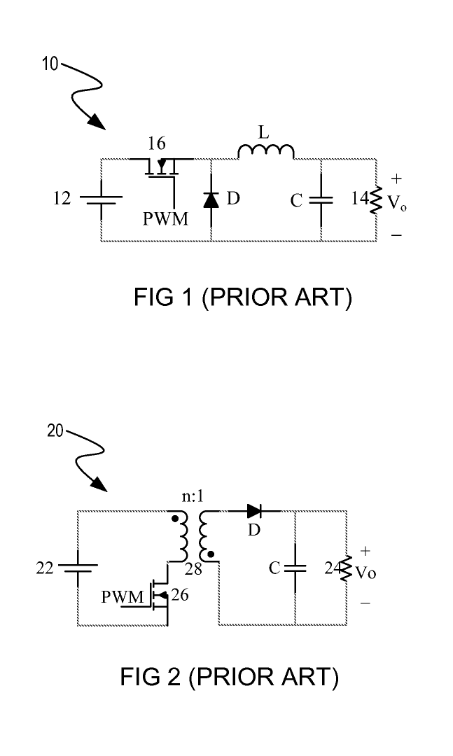

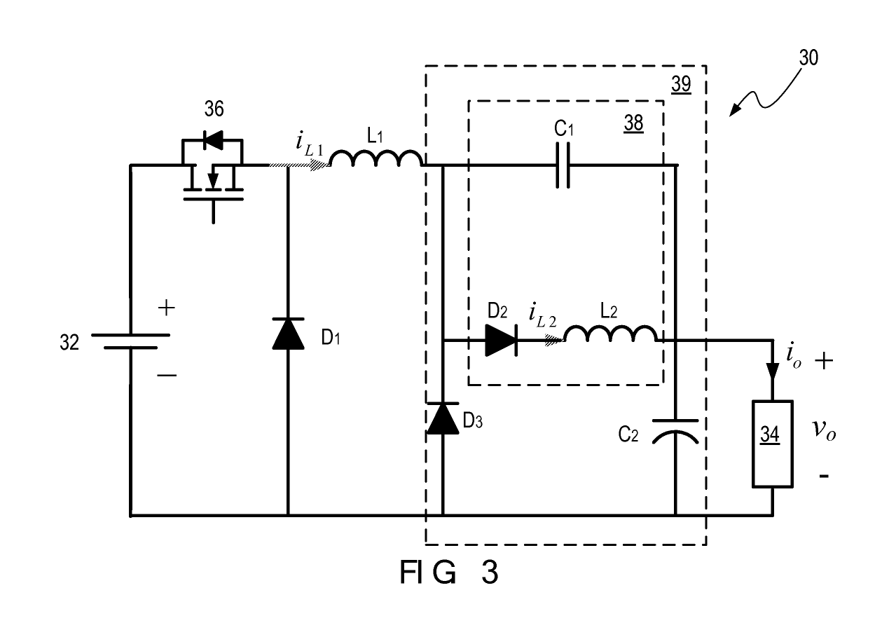

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The word “couple” we used in this specification means directly/indirectly connection. In other words, a first apparatus couples to a second apparatus indicates that the first apparatus can directly connect to the second apparatus by electrically connection, wireless connection, or optical connection, but not limited to. Or, the first apparatus can electrically or signally connect to the second apparatus via any other device or connection means indirectly.

The description of the “and/or” in this specification includes one of the listed objects or any combination of the multiple objects. In addition, unless specifically stated by this specification, otherwise, the usage of any singular terms in this specification includes the meaning of plural also.

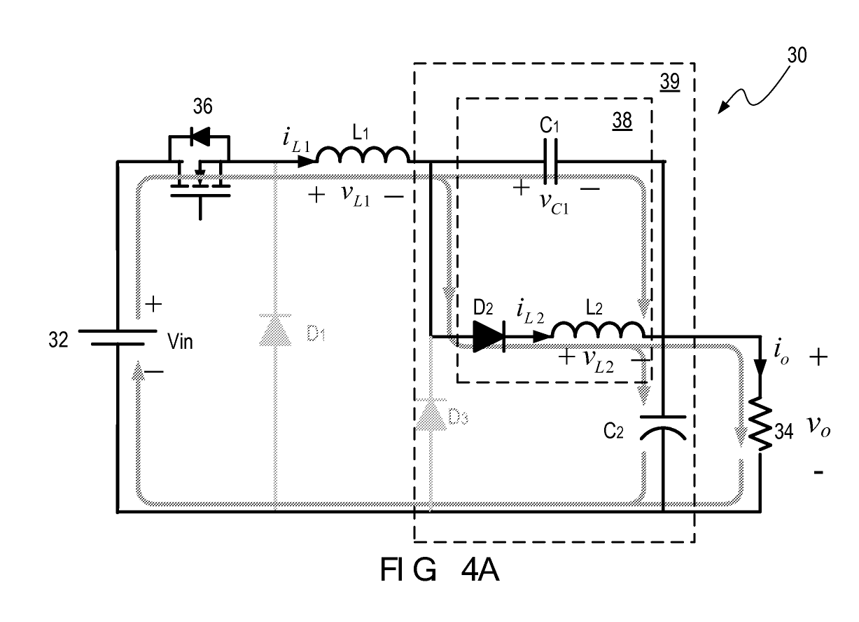

FIG. 3 illustrates a schematic of single stage step down converter 30 in accordance with one embodiment of the present invention. The step down converter 30 includes a switch 36 (such as, power transistor, but not limited to), one end of the switch 36 is coupled to a DC voltage source 32, the other end of the switch 36 is coupled to a first diode D₁ and a first inductor L₁. The step down converter 30 further includes an auto charge pump circuit 39 which includes a semi-resonant circuit 38. The semi-resonant circuit 38 includes an inductor L₂, a diode D₂ series coupled to the inductor L₂, and a capacitor C₁ parallel coupled to the inductor L₂ and the diode D₂. The semi-resonant circuit 38 is series coupled to the capacitor C₂ for voltage division. When the capacitance of the capacitor C₂ is larger than the capacitance of the capacitor C₁, the energy inputted by the voltage source 32 is stored in the semi-resonant circuit 38, so as the cross voltage of the capacitor C₁ is increase rapidly. The step down converter 30 transfers the stored energy of the capacitor C₁ to an inductor current i_{L2} by switching the switch 36 and the resonance between the inductor L₂ and the capacitor C₁. Meanwhile, the polarity of the cross voltage of the capacitor C₁ is reversed so as to turn on the diode D₃ and change the circuit structure as the auto charge pump circuit 39. Furthermore, to circuit structure can achieve the goal of the energy balance and continuous operation.

In one embodiment, the input signal of the auto charge pump circuit 39 is a pulse signal. When the pulse signal starts to provide a pulse voltage to charge the inductor L₂, the capacitor C₁ and the capacitor C₂, the capacitor C₁ resonant with the inductor L₂ via the diode D₂ and transfers the energy which stored in the capacitor to the inductor L₂, thus, the polarity of the cross voltage of the capacitor C₁ is reversed. When the cross voltage of the inductor L₂ larger than the voltage of the capacitor C₂, a current flowing through the inductor L₂ charges the capacitor C₂ through the diode D₃. When the diode D₃ is turned on, the circuit structure is changed accordingly. The cross voltages of the inductor L₂, the capacitor C₁ and the capacitor C₂ are all the same until the next pulse voltage is provided, and one cycle operation of the step down converter 30 is finish. Due to the operation of the auto charge pump circuit 39, the energy transmission between the inductor L₂, the capacitor C₁, and the capacitor C₂ is smoother.

Actually, the inductor L₁ and the inductor L₂ are two parts of the inductor of the conventional Buck converter. Due to the path which series couple the capacitor C₁ and the capacitor C₂ can be seem as short in a moment, thus when the switch 36 is turned on, the inductance of the inductor L₁ of the step down converter 30 is smaller than the inductance of the inductor of the conventional Buck converter, so as the response time of the step down converter 30 is shorter than the conventional Buck converter. When the switch 36 is turned off, the usage of the diode_{D1} is same as the diode of the conventional Buck converter. However, the ripple of the output voltage Vₒ of the step down converter 30 is small is because the operation of the auto charge pump circuit 39. In other words, the capacitor C₁ and the capacitor C₂ of the step down converted 30 can take normal capacitors which have smaller capacitance instead of the electrolytic capacitors, so as to get a longer life time.

The step down converter 30 can operate in three modes: the inductor L₁ and the inductor L₂ are operating in a continuous current mode, the inductor L₁ is operating in a discontinuous current mode and the inductor L₂ is operating in the continuous current mode, and the inductor L₁ and the inductor L₂ are operating in the discontinuous current mode. When the switch 36 is turned on, the inductor L_{I}, the auto charge pump circuit 39 and the voltage source 32 are coupled. At this time, the voltage source 32 charges the inductor L₁, the inductor L₂, the capacitor C₁ and the capacitor C₂ of the auto charge pump circuit 39. When the switch 36 is turned off, the inductor L₁ transfers the stored energy to the auto charge pump circuit 39 through the diode D_{I}. The step down converter 30 finishes a cycle of the energy transmission when the switch 36 is turned on again.

In one embodiment, the output voltage Vₒ provided by the step down converter 30 is adjustable by changing the on time of the switch 36. In another embodiment, the output voltage Vₒ is adjustable by changing the switching frequency of the switch 36.

For clearly illustration, all elements of the circuit are assumed as ideal components. The output voltage Vₒ is kept in a constant value. Meanwhile, in one embodiment, the load 34 is a resistor.

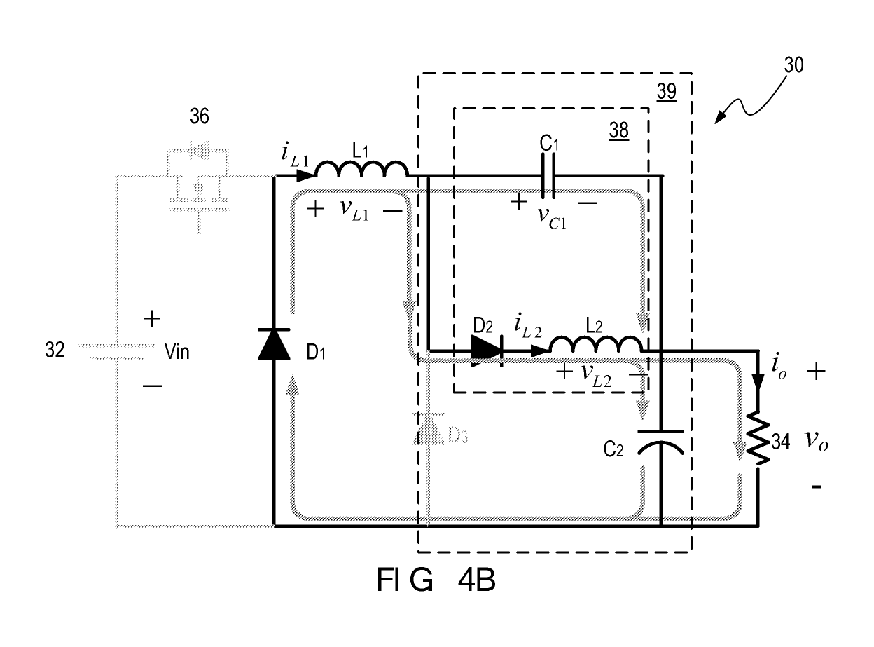

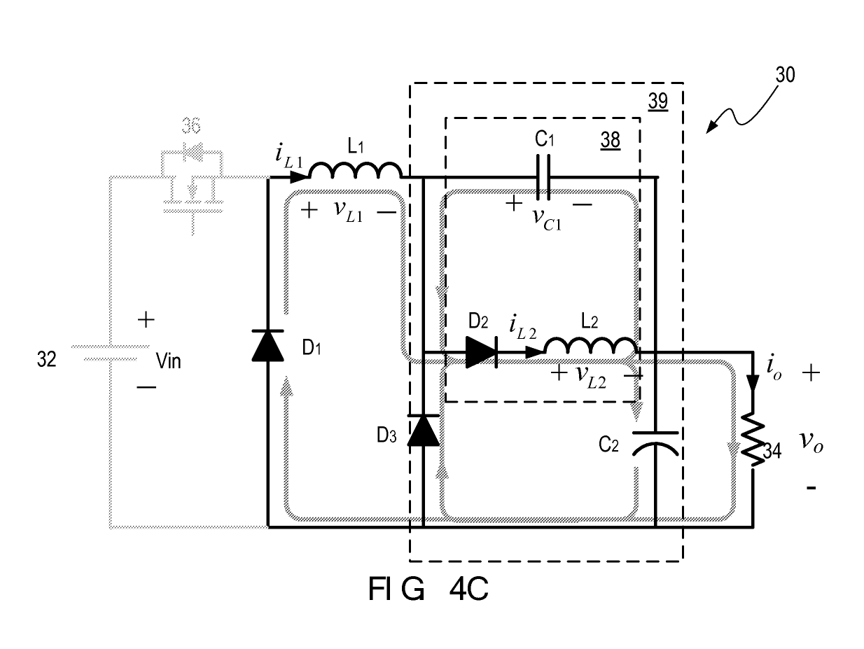

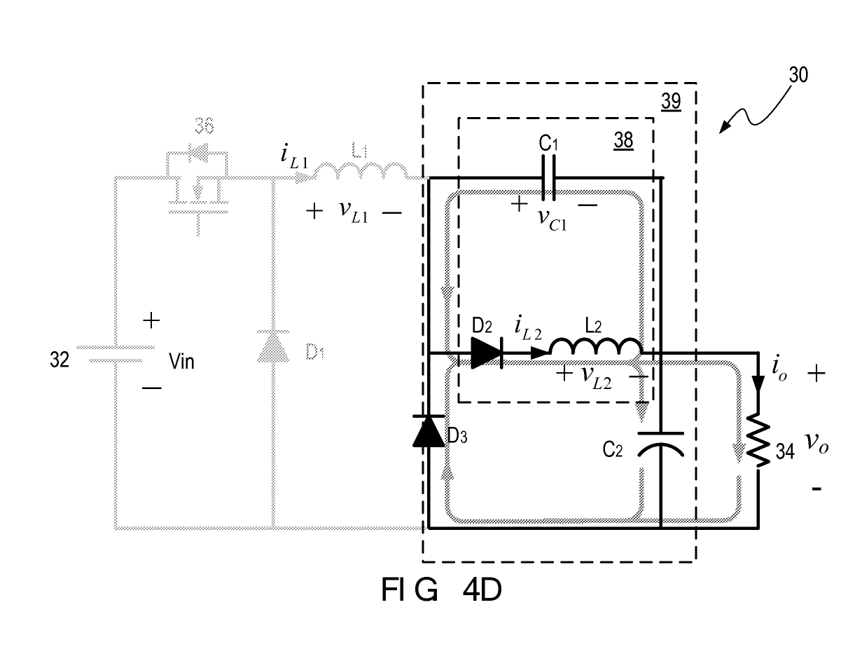

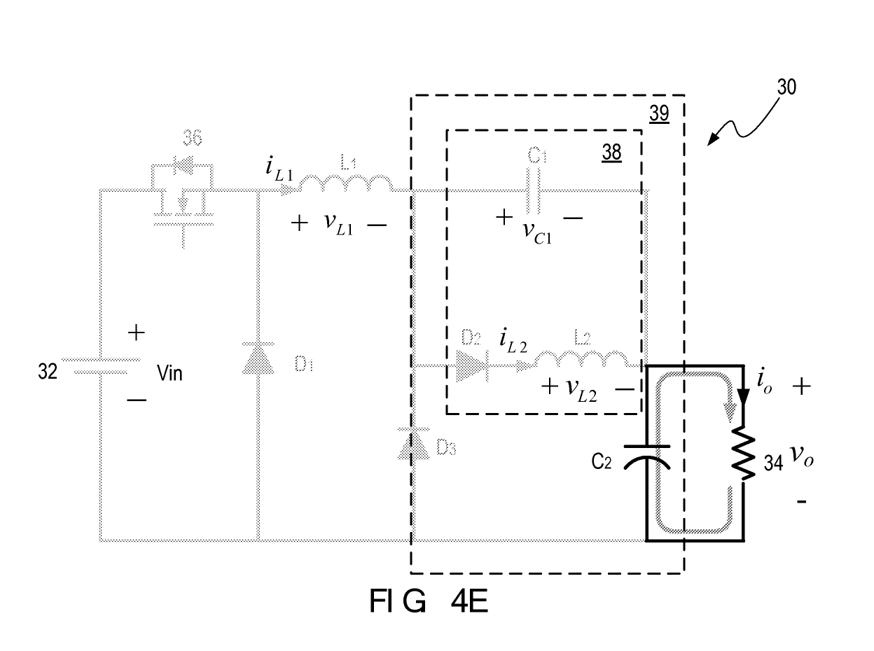

FIG. 4A illustrates an equivalent schematic of the step down converter 30 of FIG. 3 in the first mode in accordance with one embodiment of the present invention. In the embodiment, the inductor L₁ and L₂ are operating in a continuous current mode. When the switch 36 is turned on and the diode D₃ is off, the step down converter 30 is operating in a first mode. The voltage source 32 charges the inductor L₁ and the inductor L₂, the capacitor C₁ and the capacitor C₂ of the auto charge pump circuit 39. The status equations of the first mode are as following:

$$\begin{matrix}{L}_{1} \frac{d {i}_{L 1}}{d t} = {V}_{in} - {V}_{c 1} - {V}_{o} & ( 1 ) \\ {C}_{1} \frac{d {V}_{c 1}}{d t} = {i}_{L 1} - {i}_{L 2} & ( 2 ) \\ {L}_{2} \frac{d {i}_{L 2}}{d t} = {V}_{c 1} & ( 3 ) \\ C 2 \frac{d {V}_{o}}{d t} = {i}_{L 1} - \frac{{V}_{o}}{R} & ( 4 )\end{matrix}$$

FIG. 4B illustrates an equivalent schematic of the step down converter 30 of FIG. 3 in the second mode in accordance with one embodiment of the present invention. When the switch 36 is turned off, the step down converter 30 is entering a second mode. The inductor L₁ releases the energy to the auto charge pump circuit 39 through the diode D_{I}. The capacitor C₁ resonance with the inductor L₂ and restrict the direction via the diode D₂. Meanwhile, the energy stored in the capacitor C₁ is transferred to an inductor current i_{L2} and the cross voltage of the capacitor C₁ is reversed. The status equations of the second mode are as following:

$$\begin{matrix}{L}_{1} \frac{d {i}_{L 1}}{d t} = - {V}_{c 1} - {V}_{o} & ( 5 ) \\ {C}_{1} \frac{d {V}_{c 1}}{d t} = {i}_{L 1} - {i}_{L 2} & ( 6 ) \\ {L}_{2} \frac{d {i}_{L 2}}{d t} = {V}_{c 1} & ( 7 ) \\ C 2 \frac{d {V}_{o}}{d t} = {i}_{L 1} - \frac{{V}_{o}}{R} & ( 8 )\end{matrix}$$

FIG. 4C illustrates an equivalent schematic of the step down converter 30 of FIG. 3 in the third mode in accordance with one embodiment of the present invention. When the diode D₃ is on, the step down converter 30 is entering a third mode. The inductor L₂ creates a reverse voltage and charges the capacitor C₂ via the diode D₃. When the switch 36 is turned on again, the step down converter 30 finishes a cycle of the operation. The status equations of the third mode are as following:

$$\begin{matrix}{L}_{1} \frac{d {i}_{L 1}}{d t} = 0 & ( 9 ) \\ {L}_{2} \frac{d {i}_{L 2}}{d t} = {V}_{c 1} & ( 10 ) \\ {V}_{c 1} = - {V}_{o} & ( 11 ) \\ ( {C}_{1} + {C}_{2} ) \frac{d {V}_{o}}{d t} = {i}_{L 2} - \frac{{V}_{o}}{R} & ( 12 )\end{matrix}$$

FIG. 4D illustrates an equivalent schematic of the step down converter 30 of FIG. 3 in the fourth mode in accordance with one embodiment of the present invention. The fourth mode is that the inductor L₁ operates in the discontinuous current mode and the inductor L₂ operates in the continuous current mode. When the diode D₁ is off, the step down converter 30 is entering the fourth mode. The capacitor C₁, the inductor L₂ and a diode D₃ are formed as a loop and collaborate with the capacitor C₂ to transfer the energy to the load 34. When the switch 36 is turned on again, the step down converter 30 finishes a cycle of the operation. The status equations of the fourth mode are as following:

$$\begin{matrix}{i}_{L 1} = 0 & ( 13 ) \\ {L}_{2} \frac{d {i}_{L 2}}{d t} = {V}_{c 1} & ( 14 ) \\ {V}_{c 1} = - {V}_{o} & ( 15 ) \\ ( {C}_{1} + {C}_{2} ) \frac{d {V}_{o}}{d t} = {i}_{L 2} - \frac{{V}_{o}}{R} & ( 16 )\end{matrix}$$

FIG. 4E illustrates an equivalent schematic of the step down converter 30 of FIG. 3 in the fifth mode in accordance with one embodiment of the present invention. The fourth mode is that the inductor L₁ and the inductor L₂ operate in the discontinuous current mode. When the diode D₃ is off, the step down converter 30 is entering the fifth mode. At this mode, the energy is provided to the load 34 only by the capacitor C₂. When the switch 36 is turned on again, the step down converter 30 finishes a cycle of the operation. The status equations of the fifth mode are as following:

$$\begin{matrix}{i}_{L 1} = 0 & ( 17 ) \\ {i}_{L 2} = 0 & ( 18 ) \\ {V}_{C 1} = 0 & ( 19 ) \\ {C}_{2} \frac{d {V}_{o}}{d t} = - \frac{{V}_{o}}{R} & ( 20 )\end{matrix}$$

The present invention provides a single stage step down converter which integrates a step-down converter (Buck) and an auto charge pump circuit. The circuit structure of the step down converter is adjustable due to the design of the parameters and the function of the resonant circuit. Users may design the circuit parameters of the step down converter to force the input current of the step down converter has fast response when the step down converter operating in the energy-inputting mode. And, when the step down converter operates in the energy-outputting mode, the output voltage of the step down converter has relative lower ripple. Moreover, the present invention of the step down converter provides the advantage of low ripple of the output voltage, the circuit design can be avoided using electrolytic capacitors which has relative larger capacitance, and thus to prolong the life time of the circuit. And the presented step down converter embedded an auto charge pump circuit to avoid the capacitor saturation of the semi-resonant circuit, thus, no any active components required. The step down converter can achieve the goal of circuit structure adjustable, energy balance, fast response, low output ripple and the long life time.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A step down converter, comprising:
a switch, one end of said switch coupled to a DC voltage source, the other end of said switch coupled to a first inductor and a first diode which serial coupled to said first inductor; and
an auto charge pump circuit coupled to said first inductor and said first diode, operable for providing an output current to a load.

2. The converter as claimed in claim 1, wherein said auto charge pump circuit comprises:
a semi-resonant circuit;
a first capacitor series coupled to said semi-resonant circuit; and
a second diode parallel coupled to said first capacitor and said semi-resonant circuit.

3. The converter as claimed in claim 2, wherein said semi-resonant circuit comprises:
a second inductor and a third diode coupled in series; and
a second capacitor parallel coupled to said second inductor and said third diode.

4. The converter as claimed in claim 3, wherein one end of said second capacitor is coupled to said first inductor, and wherein the other end of said second capacitor is coupled to said first capacitor, said second inductor, and said load.

5. The converter as claimed in claim 1, wherein said switch is a power transistor.

6. The converter as claimed in claim 1, wherein said auto charge pump circuit is a voltage type auto charge pump circuit.
